(19) United States
(12) Patent Application Publication
(10) Pub. No.: US 2013/0282418 A1
(43) Pub. Date: Oct. 24, 2013

(54) SYSTEM AND METHOD FOR FIELD SERVICES AUTOMATION

(71) Applicants: George G. Furman, Lebanon, IN (US); Kenneth J. Crocker, Indianapolis, IN (US); Julia M. Hochstatter, Fishers, IN (US)

(72) Inventors: George G. Furman, Lebanon, IN (US); Kenneth J. Crocker, Indianapolis, IN (US); Julia M. Hochstatter, Fishers, IN (US)

(73) Assignee: Firestone Building Products Company, LLC, Indianapolis, IN (US)

(21) Appl. No.: 13/997,567

(22) PCT Filed: Dec. 30, 2011
(86) PCT No.: PCT/US11/68099

§ 371 Date: Jun. 24, 2013

Related U.S. Application Data
(60) Provisional application No. 61/428,451, filed on Dec. 30, 2010.

(51) Int. Cl. G06Q 10/06

(52) U.S. Cl. CPC G06Q 10/06311
USPC 705/7.13

(57) ABSTRACT

A portable representative device manages the administrative workload of a field technical representative. The portable representative device includes a processor programmed to present a technical field representative with a list of selectable scheduled tasks assigned to the field technical representative, each of the selectable scheduled tasks associated with a roof. The field technical representative is presented with a task-specific form for a selected scheduled task. The task-specific form includes a plurality of fields to collect field data for the roof of the selected scheduled task from the field technical representatives. Field data from the field technical representative is collected using the task-specific form, the field data including a roof plan of the roof of the selected scheduled task. The collected field data is submitted to a central control system. A system and method are also included.

### BACKGROUND

The subject matter of the present disclosure broadly relates to resource management. The examples herein find particular application in conjunction with managing data resources and field technical representatives in the roofing industry, and will be described herein with particular reference thereto. However, it is to be appreciated that the present exemplary embodiments are also amenable to other like applications. For example, it is contemplated that the present exemplary embodiments are employed for field representatives other than field technical representatives in the roofing industry.

Roofing manufacturers sell commercial roofing systems, such as single-ply systems, metal systems, asphalt-based systems, and the like, to customers, such as contractors for installation on commercial buildings, such as apartment buildings, retail outlets, industrial facilities, medical facilities, and the like. Typically, to ensure such roofing systems are installed properly, roofing manufacturers employ field technical representatives to provide service to contractors and end-customers, such as training as to the installation of the roofing systems and/or to inspect installed roofing systems for any one of various reasons. In some cases, this inspection function of field technical representatives can be used to verify proper installation of the roofing system, as warranty claims are often dependent upon a proper installation. Roofing manufacturers further employ the field technical representatives to investigate warranty issues that may arise over the lifetime of a roofing system.

Field technical representatives are typically construction professionals with keen observation skills, hands-on roofing experience, and the ability to communicate with customers regarding technical issues. In many cases, field technical representatives may be based out of an independent office (e.g., a personal home office) and are typically charged with managing defined geographical territories. Tasks commonly associated with managing a territory include providing installation training, technical customer service, sales support, rooftop inspections (including interim inspections, final inspections and re-inspections), investigating warranty claims and product claims, and the like.

Periodically, such as every week, field technical representatives may receive documents, electronic or otherwise, that list projects located within the defined geographic territory of the field technical representative that are ready for inspection and/or investigation. A variety of approaches are used by field technical representatives to organize and plan for the completion of these projects. For example, some representatives may arrange their schedules by contacting customers based on the number of jobs under the customers' names. As another example, some manually plot the project zip codes using known mapping software, such as MICROSOFT STREETS AND TRIPS, for example, to gain a visual impression of job locations and then arrange their schedule based on a planned travel route or area. Typically, field technical representatives will perform many inspections and/or investigations during the week, and then message documents, electronic or otherwise, containing the results of the inspections and/or investigations conducted during that week back to a regional or central office of the roofing manufacturer. In certain instances, a person at the regional or central office may manually key some (e.g., a summary) or all of the information received from the field technical representatives into a legacy database application. Additionally, or in the alternative, this information may simply be stored in a document database for archiving and/or record retention purposes.

One problem with the organization and arrangement techniques described above is that the manual process of plotting jobs and scheduling projects, combined with the administrative tasks related to messaging inspection and/or investigative results, typically requires a minimum of one day a week of “clerical office time” by the field technical representative. In some cases, “clerical office time” may be deemed an inefficient and/or less valuable use of the time and expertise of field technical representatives, and may pull the field technical representative away from the customers, thereby consuming time that could be better spent performing other tasks, such as managing the quality of installations through trainings, investigations, inspections, and the like.

Another problem with the arrangement mentioned above is that most of the data collected by the field technical representatives may be returned to the roofing manufacturer in an image form. The ability to easily generate reports on areas for improvement may be inefficient and time consuming to accomplish without looking at each individual image and manually compiling the inspection findings to form a performance picture. Further, while some of the data collected by representatives may be entered into a legacy database application, often this only involves entering administrative data since it may be unwieldy to manually enter all the information received from the field technical representatives.

The present disclosure contemplates new and improved systems and/or methods for remedying these and/or other problems.

### BRIEF DESCRIPTION

One example of a portable representative device for managing the administrative workload of a field technical representative in accordance with the subject matter of the present disclosure is provided. The portable representative device can include at least one processor programmed to present a technical field representative with a list of selectable scheduled tasks assigned to the field technical representative. In some cases, at least one of the selectable scheduled tasks can be associated with a roof installation or project. A selection of one of the selectable scheduled tasks is received from the field technical representative and the field technical representative is presented with a task-specific form for the selected scheduled task. The task-specific form can include a plurality of fields to collect field data for the roof of the selected scheduled task. Field data from the field technical representative is collected using the task-specific form. In some cases, the field data can include a roof plan of the roof of the selected scheduled task. The roof plan can include a plurality of waypoints defining the perimeter of the roof of the selected scheduled task and one or more areas of interest of the roof of the selected task. The collected field data can be submitted to a central control system.

Another example of a portable representative device for managing the administrative workload of a field technical representative in accordance with the subject matter of the present disclosure is provided. The portable representative device can include a display device, an input device (e.g., a user input device or a communication unit), an output device (e.g., a display or a user communication unit) and a processor communicatively coupled with the display device and the input device (e.g., by at least one databus). The processor is programmed to display on the display device a list of selectable scheduled tasks assigned to the field technical representative to a user associated with the portable representative device, such as a technical field representative. In some cases, at least one of the selectable scheduled tasks can be associated with a roof installation or project. A selection of one of the selectable scheduled tasks is received from the user using the input device and a task-specific form for the selected scheduled task is displayed on the display device to the user. The task-specific form can include a plurality of fields to collect field data for the roof of the selected scheduled task. Field data from the field technical representative is collected using the task-specific form. In some cases, the field data can include a roof plan of the roof of the selected scheduled task. The roof plan can include a plurality of waypoints defining the perimeter of the roof of the selected scheduled task and one or more areas of interest of the roof of the selected task. The collected field data can be submitted to a central control system using the communication unit over, for example, a communication network.

One example of a method for managing field technical representatives in accordance with the subject matter of the present disclosure is provided. The method can be performed by at least one processor and include presenting a field technical representative with a list of selectable scheduled tasks assigned to the field technical representative. In some cases, at least one of the selectable scheduled tasks can be associated with a roof installation or project. The method can also include receiving a selection of one of the selectable scheduled tasks, such as from the field technical representative, and presenting a task-specific form for the selected scheduled task based on the selection received. The task-specific form can include a plurality of fields that can be used to collect field data for the roof of the selected scheduled task. The method can also include collecting field data, such as, for example, from the field technical representative, using the task-specific form. The field data can include a roof plan of the roof of the selected scheduled task. The roof plan can include a plurality of waypoints defining the perimeter of the roof of the selected scheduled task and one or more areas of interest of the roof of the selected task. The method can also include submitting the collected field data to a central control system.

One example of a quality monitoring system in accordance with the subject matter of the present disclosure can include a plurality of portable representative devices. The plurality of portable representative devices can be associated with a field technical representative and can be operative to collect field data from the field technical representative using an electronic, task-specific form. The task-specific form can include a plurality of fields to collect field data for a roof of a task assigned to the field technical representatives. The field data can include a roof plan of the roof, where the roof plan includes a plurality of waypoints defining the perimeter of the roof and one or more areas of interest. The quality monitoring system can further include at least one processor programmed to receive field data from the portable representative devices. In some cases, the field data can be indicative of conditions and circumstances surrounding a warranty claim or other roof installation event. In this manner, the received field data can be analyzed to identify warranty claims and/or other roof installation design defects and/or limitations of the roof and the identified roof failures are presented to an analyst.

### BRIEF DESCRIPTION OF THE DRAWINGS

FIG. 1 is a block diagram of one example of a system for managing field technical representatives, and collecting and analyzing roofing data collected by the representatives according to features of the present disclosure.

FIG. 2 is a block diagram of one example of a SIMON module according to features of the present disclosure.

FIG. 3 is one example of a pre-installation notice form.

FIG. 4 is one example of a home page.

FIG. 5 is one example of a contractor search page.

FIG. 6 is one example of a search results page for a contractor search.

FIG. 7 is one example of a contractor page.

FIG. 8 is one example of a task management page.

FIG. 9 is one example of a task page.

FIG. 10 is one example of a form for collecting and/or displaying basic information for a task from and/or to a representative.

FIG. 11 is one example of a form for collecting and/or displaying training information for a task to and/or from a representative.

FIG. 12 is one example of a form for collecting and/or displaying event information for a task to and/or from a representative.

FIG. 13 is one example of a form for collecting and/or displaying contact information for a task to and/or from a representative.

FIG. 14 is one example of a form for collecting and/or displaying claim detail for a task to and/or from a representative.

FIG. 15 is one example of a form for collecting and/or displaying attendee and weather information for a task from and/or to a representative.

FIG. 16 is one example of a form for collecting and/or displaying exterior images for a task to and/or from a representative.

FIG. 17 is one example of a form for collecting and/or displaying interior images for a task to and/or from a representative.

FIG. 18 is one example of a form for collecting and/or displaying roof areas for a task to and/or from a representative.

FIG. 19 is one example of a form for collecting and/or displaying roof images for a task to and/or from a representative.

FIG. 20 is one example of a form for collecting and/or displaying roof plans for a task to and/or from a representative.

FIG. 21 is one example of a form for collecting and/or displaying areas of interest for a task to and/or from a representative.

FIG. 22 is one example of a form for collecting and/or displaying closeout information for a task to and/or from a representative.

FIG. 23 is one example of a summary page for a task-specific form.

FIG. 24 is one example of a page of a task-specific form.

FIG. 25 is a block diagram of one example of method for managing field technical representatives according to features of the present disclosure.

### DETAILED DESCRIPTION

Among other features, the subject matter of the present disclosure can generate increases in operational efficiency of field technical representatives by reducing administrative workload, thus allowing additional time to focus on core responsibilities. The subject matter of the present disclosure can streamline processes related to the performance of technical customer services tasks through incorporation of custom software into hand-held devices carried by the representatives in the field. Tasks include, for example, providing installation training, technical customer service, sales support, rooftop inspections (including interim inspections, final inspections and re-inspections), investigating warranty claims and product claims, and the like.

The custom software allows representatives to efficiently schedule assigned tasks. Representatives suitably build itineraries based on geographic location of the tasks and customer interaction. Therefore, pre-installation notice (PIN) data and warranty data are combined in an interactive mapping program such that the representatives can see scheduled tasks plotted on a map. This permits the creation of increasingly efficient schedules through a point-and-click process and then, in some embodiments, can permit the automatic posting of the schedule to an electronic calendar, such as via MICROSOFT OUTLOOK, for example.

Further, the custom software provides the representatives with current itineraries of tasks to complete. When a representative selects a task from the current itinerary, the representative can access an electronic, task-specific form (i.e., a form dependent upon the task type) that steps the representative through a predetermined process to collect data for the task. The task-specific form suitably employs data standardization to allow accurate reporting. However, generic comment fields may be employed if necessary.

The task-specific forms typically include a sub-form for generating a digital roof plan and marking areas of interests, such as roof penetrations and/or deficiencies, thereon. A representative can walk the roof perimeter to define the boundaries of the roof and can walk the roof to locate areas of interest. Insofar as an area of interest is located, a “geo-stamp” (coordinate tag) can be marked on the roof plan. The representative can then capture images of the area of interest and/or specifies information regarding the area of interest.

Once a task is completed (i.e., the representative reaches the end of the task-specific form), the collected data is provided to a central control system. If a data connection, wireless or otherwise, exists when the task is completed, the data collected for the task is transmitted across a communications network to the control system. Otherwise, the data collected for the task is saved locally until a data connection is available. The collected data may be recalled at later times. For example, a roof plan of areas of interest may be recalled from a previous inspection and/or investigation. Further, in certain embodiments, a global positioning system (GPS) may be employed to guide a representative to previously marked areas of interest.

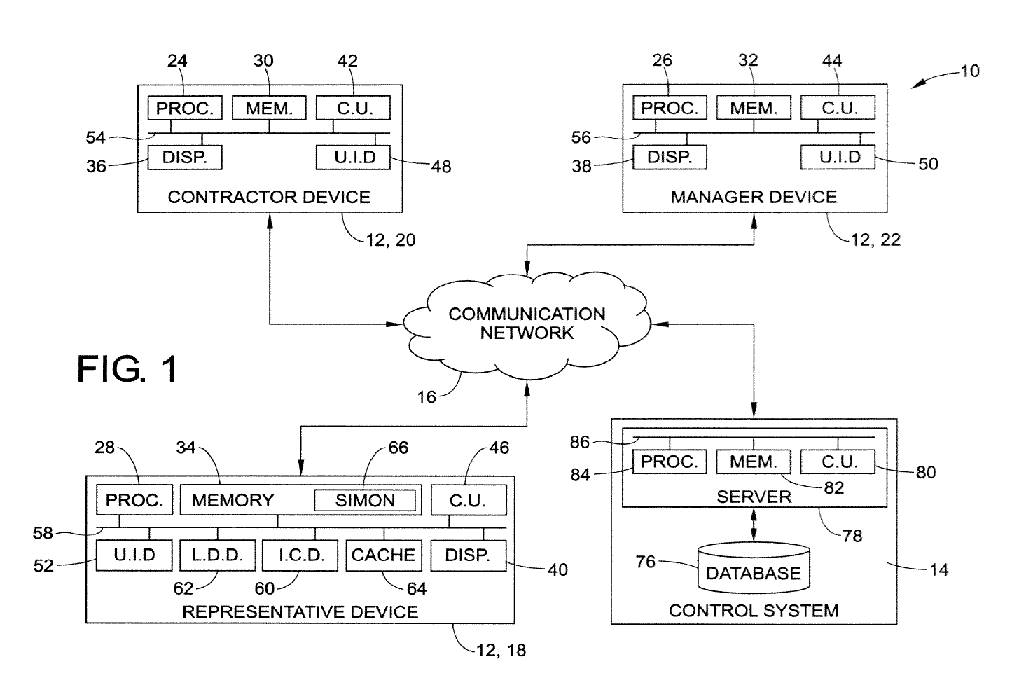

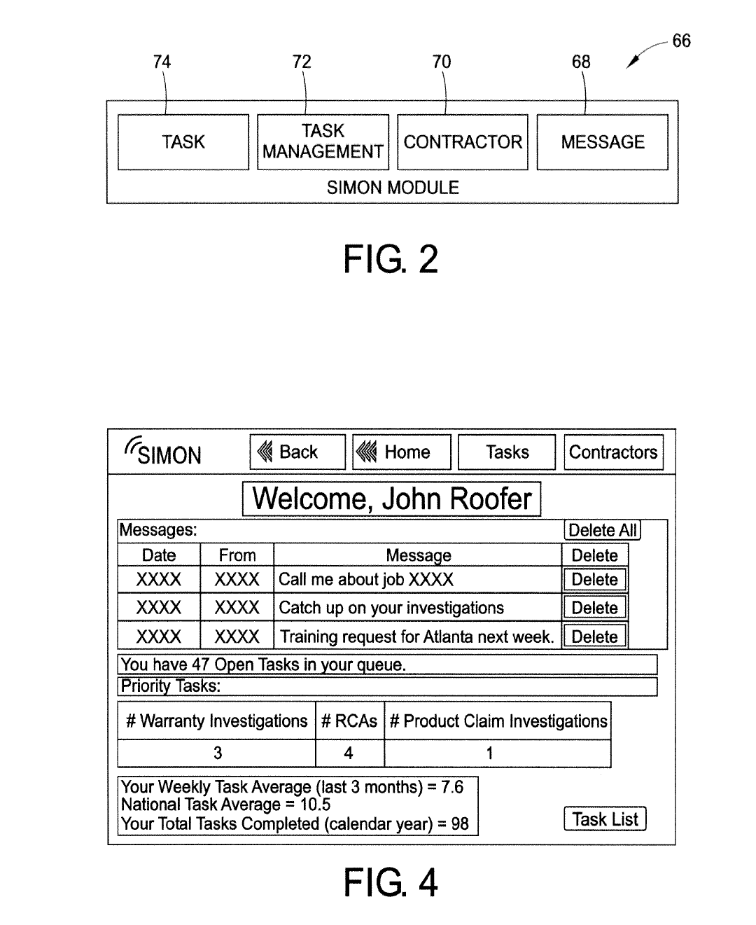

With reference to FIGS. 1 and 2, a system 10 includes one or more user devices 12 exchanging data with a central control system 14 over a communication network 16, such as one or more of the Internet, a local area network, a wide area network, a wireless network, and the like. As discussed hereafter, control system 14 can be managed, operated and/or used by a roofing manufacturer employing field technical representatives. It serves as a repository for data collected by the representatives, facilitates task assignment and messaging between users, facilitates report generation by management, and more.

User devices 12 are each associated with at least one user, such as a contractor, manager, or representative, of system 10, and the users each include a role and, optionally, access controls. User roles include representative, contractor and manager corresponding, as the names suggest, to representatives, contractors, and managers, respectively. The access controls control user access to control system 14. Further, the access controls for a user are typically dependent upon the role of the user. However, the access controls can also be specific to users, groups, or the like. The user roles and the access controls are maintained and enforced by control system 14, which identifies a user through authentication using, for example, a username and password.

User devices 12 employed by representatives, contractors, and administrators are also known as representative devices 18, contractor devices 20 and managers devices 22, respectively. As discussed below, the structure and functionality of user devices 12 vary depending upon the type of user device. For example, a representative device typically serves to, among other things, allow a representative to collect data in the field and is typically a portable computer. As another example, a manager device typically serves to, among other things, allow a manager to create and assign tasks to representatives and is typically a desktop computer. As another example, a contractor device typically serves to, among other things, allow a contractor to submit PINs and view inspections on projects the contractor is associated with. Further, a user device may support a plurality of different user roles.

Each of user devices 12 are digital processing devices including a processor 24, 26, 28, a memory 30, 32, 34, a display device 36, 38, 40, a communication unit 42, 44, 46, a user input device 48, 50, 52, and at least one data bus 54, 56, 58. Further, each of representative devices 18 typically includes one or more of an image-capture device 60, such as a digital camera, a location-determination device 62, such as a global position system (GPS) transceiver, and a cache 64, such as a memory. Communications units 42, 44, 46 provide processors 24, 26, 28 with an interface to communication network 16 to allow user devices 12 to interact with other components of system 10, such as control system 14, over communication network 16. For representative devices 18, communication unit 16 is typically a wireless transceiver, such as, for example, an 802.11a, b, g, or n transceiver or a 3^{rd} or 4^{th} generation mobile telecommunications transceiver. Memories 30, 32, 34 include computer executable instructions for performing the functionality of user devices 12, which are executed by processors 24, 26, 28. Display devices 36, 38, 40 allow a user interface to be presented to the users and user input devices 48, 50, 52 allow the users to interact with the user interface. Data buses 54, 56, 58 interconnect the components of user devices 12. Examples of user devices include, for example, computers, smart phones, personal digital assistants, tablet computers, computers with touch screen displays, and the like.

Contractor devices 20 are typically desktop or laptop computers allowing the contractors to access control system 14 over communication network 16 to perform one or more operations. Operations include, for example, submitting PINs, submitting requests for inspections and/or re-inspections, viewing information pertaining to selected projects, submitting warranty claims, and the like. Such information typically includes one or more of PINs, inspection results, warranties, and the like. Submissions to control system 14 are typically performed by filling out electronic forms. However, submissions may also be made through submission of images of forms (referred to hereafter as legacy forms).

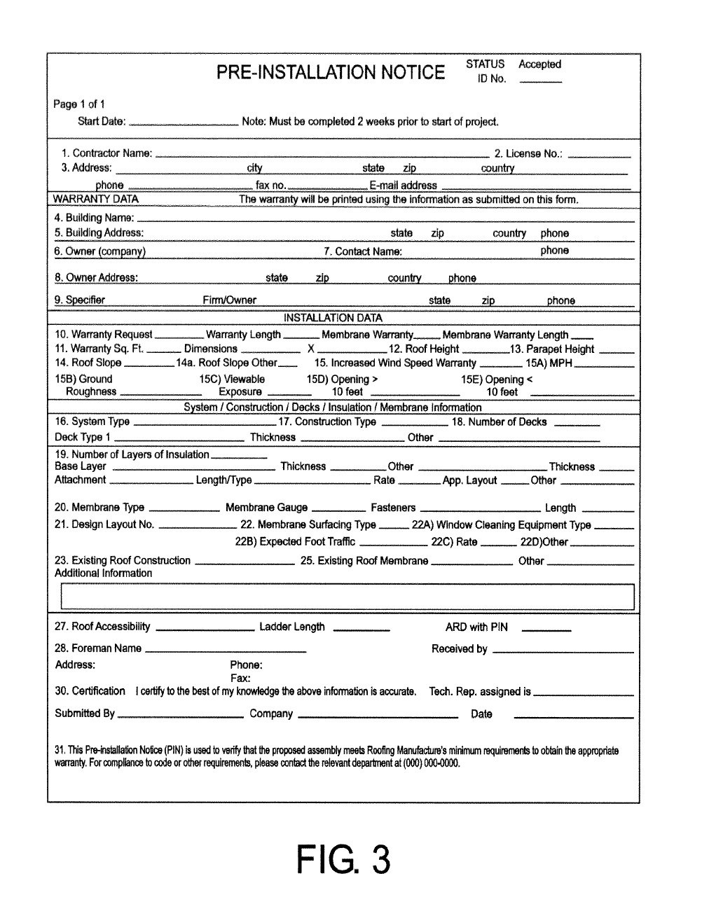

A PIN is submitted to control system 14 when a contractor seeks to obtain a warranty on a roof from the roofing manufacture that is being installed by the contractor. An example of a PIN is illustrated in FIG. 3. The contractor specifies information regarding the warranty that is desired, such as, for example, the length of the warranty, and information regarding the installation, such as roof slope and membrane type. The roofing manufacturer, typically a manager, then reviews the PIN and determines whether to tentatively issue the requested warranty for the installation pending verification of the installation. If the requested warranty terms are determined to be unacceptable, the roofing manufacturer may negotiate with the contractor to modify parameters of the PIN before creating the project and assigning the associated tasks. Further, the roofing manufacture may, in some cases, allow certain deviations from normal installation procedures.

A request for inspection and/or re-inspection of a project is typically performed in connection with a PIN. Namely, typically after submitting a PIN which has been tentatively issued, the contractor installs the roof as set forth or otherwise described in the PIN. Once the installation is completed, the contractor typically submits a request for inspection. However, in some embodiments, it is also possible to submit the request for inspection with the PIN. A representative then verifies the roof was installed properly. Insofar as deficiencies are detected, the representative notifies the contractor thereof to allow the contractor to take corrective action. Minor issues may be dealt with while the representative is on site, but more substantial deviations will generally require the contractor to submit a request for re-inspection. Inspections continue until the representatives are satisfied that the roof is installed properly. Once the representatives are satisfied, the warranty can be issued.

Contractor devices 20 further provide the contractors with a user interface on corresponding display device 36, 38, 40 for receiving user input from the corresponding user interface to access control system 14. The user interface can take the form of a web page hosted by control system 14. However, other types of user interfaces are contemplated. For example, the user interface can be a software module installed on the customer devices. The software module and/or the user interface may receive updates and/or customizations from control system 14. Customizations can be global and/or user specific (e.g., user preferences).

In some embodiments, the software module and/or the user interface caches data locally to allow the contractors to carry out one of more of the above described operations without control system 14. As to submissions, the contractors can make the submissions to the cache, which saves the submissions until a connection to control system 14 is established. The submissions are then transmitted to control system 14. As to viewing, the cache stores information from control system 14. The stored information can, for example, include information for projects with activity over a past predetermined amount of time, such as sixty days, that are associated with the contractor.

Representative devices 18 are typically portable computers including a scheduling and inspection mobile operation navigation (SIMON) module 66 for streamlining the administrative workload of representatives. SIMON module 66 includes a plurality of sub-modules that work in unison to help the representatives manage their administrative workloads. Further, SIMON module 66 is typically software included on memories 34 of representative devices 18 and executed by processors 28 of representative devices 18. However, it is also contemplated that at least some of SIMON module 66 is hardware.

When SIMON module 66 is started, the representative is presented with a home page on a user interface, an example of which is illustrated in FIG. 4. The home page typically presents the representative with a plurality of actions the representative can perform, including, for example, searching for contractors, task management, and deleting messages. Additionally, the home page typically presents the representative with useful information pertaining to their responsibilities. For example, the representative can be presented with one or more messages received from other users and/or components of system 10, statistics regarding representatives, information regarding assigned tasks, and the like. As another example, the representative can be presented with a list of scheduled tasks for the present day.

A message sub-module 68 of SIMON module 66 is employed to receive and, optionally, act upon the received messages (e.g., delete a message). Message sub-module 68 allows the representatives to exchange messages with other parties, including other users of system 10. For example, a first representative can send a message to a second representative. Further, as discussed below, message sub-module 68 can also be employed to receive messages from components of system 10, such as control system 14. Such messages can, for example, provide the users automated reminders of scheduled tasks. In addition to receiving and sending messages, the representatives can also delete messages.

The messages of message sub-module 68 are typically maintained on, and/or exchanged through, control system 14. When a representative wants to read and/or otherwise access their messages, message sub-module 68 submits requests to control system 14 corresponding to the representative requests. Similarly, when a representative wants to create and/or send messages, message sub-module 68 submits requests to the control module corresponding to the representative requests. In other embodiments, message sub-module 68 maintains the messages locally on representative devices 18 and exchanges the messages directly between user devices 12. In both embodiments, an email communication protocol, such as internet message access protocol (IMAP), post office protocol (POP), and simple mail transfer protocol (SMTP), can be used for the exchange of messages.

In some embodiments, SIMON module 66 further communicates with control system 14 to receive statistics regarding representatives and information regarding assigned tasks. Statistics regarding representatives include, for example, weekly task average over a predetermined period of time, such as three months, for the representative, average weekly task average over the predetermined period of time for a group of representatives, such as other national representatives, total tasks completed over a predetermined period of time, such as the calendar year, and so on. Information regarding assigned tasks includes, for example, the number of open tasks and/or the number of priority tasks, such as tasks relating to warranty investigations, roof condition analyses (RCAs), and product claim investigations.

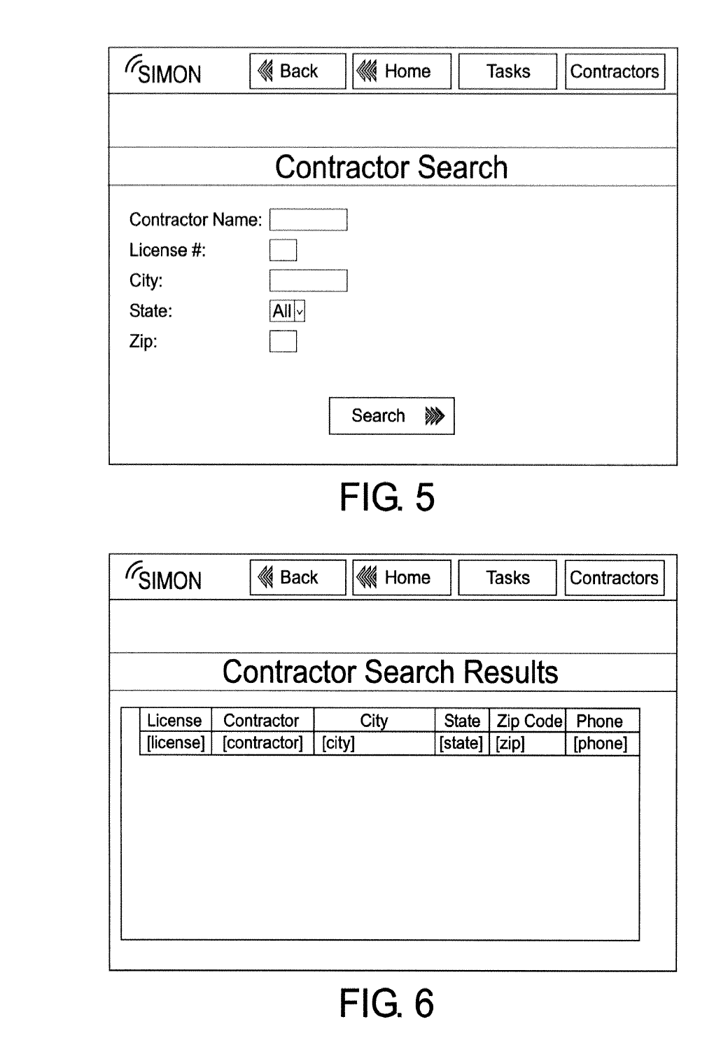

When a representative indicates a desire to search for contractors, the representative is presented with a search page, one example of which is shown in FIG. 5. Searching for contractors available through system 10 can be performed based on one or more parameters of with the contractors. Parameters include, for example, name, license number, address, city, state, zip code, phone number, fax number, and so on. Search results are returned on a search results page, an example of which is shown in FIG. 6, as a list of selectable contractor entries, each contractor list can include information for one or more parameters of the contractors.

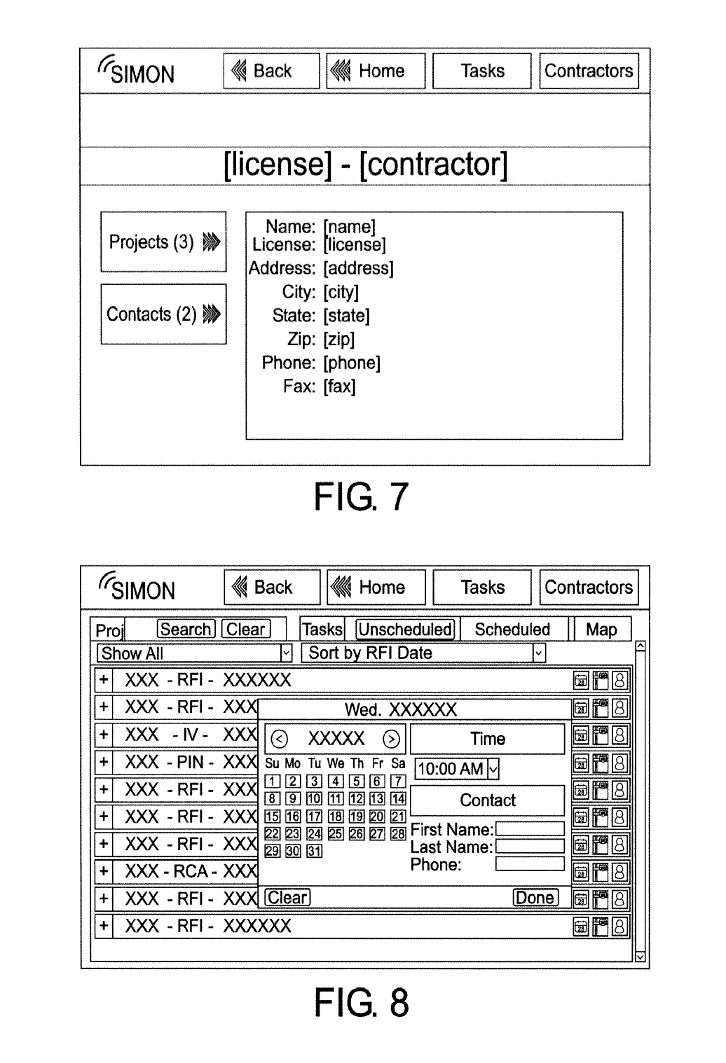

In some embodiments, selecting an entry from the list allows the representative to view a contractor page, an example of which is shown in FIG. 7, including information about the contractor identified in the selected entry. Such information includes, for example, one or more of information for parameters of the contractor, such as parameters that were not displayed in the contractor list entries of the search result, information regarding contacts associated with the contractor, and information regarding projects and/or tasks associated with the contractor. Parameters associated with contacts include, for example, one or more of a name, phone number and email address. Parameters associated with projects and/or tasks include, for example, one or more of project number, job name, contractor name, job size (e.g., square feet), roof membrane type, roofing system, and the like. The contacts and/or the projects associated with the contractor may be shown in separate pages as the contractor page.

A contractor sub-module 70 of SIMON module 66 is employed to perform the searching for contractors and access of contractor information. Contractor sub-module 70 retrieves contractor information from control system 14, including the above noted parameters. Further, contractor sub-module 70 allows searching of contractor information stored on control system 14. In some embodiments, contractor sub-module 70 may store contractor information stored on control system 14 in cache 64 of the representative device 18. For example, contractor information for all or a subset of contractors can be stored. Advantageously, this allows for retrieval and/or searching of contractor information without a connection to control system 14.

When a representative indicates a desire to perform a task management operation, the representative is presented with a task management page, one example of which is shown in FIG. 8. As noted above, tasks include, for example, providing installation training, technical customer service, sales support, rooftop inspections (including interim inspections, final inspections and re-inspections), investigating warranty claims and product claims, and the like. In general, each task type will usually involve a representative going into the field and collecting a different set of field data.

The task management page includes one or more lists of tasks assigned to the representative. Lists include, for example, one or more of all pending tasks, completed tasks over a predetermined period of time, pending unscheduled tasks, pending scheduled tasks, and so on. In some embodiments, the lists can be searched and/or filtered based upon parameters of the tasks, such as, for example, job number, task type, job name, job city, job state, contractor, roofing system type, warranted square footage, contractor license number, quality incidence rating, contractor phone number, PIN date, request for investigation date, and the like. Typically, the lists are presented in a tabbed arrangement, but other arrangements are contemplated. For example, the task management page can be spread across a plurality of pages, each including a list.

Each task is represented as a selectable task list item. Such a task list item includes information for one or more parameters of the task. As noted above, parameters include, for example, job name and project name. In some embodiments, a task list item is expandable to display information for additional parameters of the task. For example, selecting a plus sign adjacent the task list item expands the task list item. Further, in some embodiments, each task list items include selectable action objects, such as buttons or text, that perform operations on the corresponding task when selected. It is, however, contemplated, that the action objects are generic to task list items and operate on the presently selected task list item or task list items.

Operations that can be performed by action objects include one or more of reassigning a task to another representative, scheduling a task, rescheduling a task, mapping the location of a task, unscheduling a task, generating and/or printing driving directions to a selected task, and so on. Selecting reassignment allows a representative to enter and/or select another representative. Selecting scheduling or rescheduling allows a representative to enter a date and, optionally, time and/or a contact to be associated with the project the task relates to. Selecting unscheduling unschedules the task, optionally after verifying the representative intended to unscheduled the task with, for example, with a user prompt. Selecting mapping displays a map showing the location of the task, as discussed below. In certain embodiments, a representative's electronic calendar, such as, for example, a MICROSOFT OUTLOOK calendar, is updated when a task is reassigned, scheduled, rescheduled, or unscheduled.

Operations that can be performed on tasks may be limited depending upon the status of the task. For example, completed tasks may not be modifiable and unscheduled tasks typically cannot be unscheduled. Further, in certain embodiments, operations, such as reassigning tasks, may be limited to certain representatives, such as senior or higher ranked representatives, and/or require manager approval.

The task management page further includes a map, which is typically displayed in a tabbed arrangement with the lists. However, as noted above, the task management page can be spread across a plurality of pages, for example, including the map and the lists on different pages. The map displays the geographical location of one or more tasks of the representative, represented as selectable markers. In certain embodiments, different task types may be associated with different markers. Further, in certain embodiments, the representative can zoom in and out of the map. Even more, in certain embodiments, the representative can set the viewing area based on one or more parameters of displayed tasks, such as, for example, contractor, zip code (3-5 digits), date, and the like.

Displayed tasks typically include the tasks in a selected one of the lists, optionally filtered according to parameters of the tasks. For example, a representative can select the scheduled tasks list and, optionally, filter the tasks based on task type. Further, selecting one of the markers suitably prompts or otherwise allows the representative to perform one or more of the above described operations on the selected task, such as generating driving directions to the task.

A task management sub-module 72 of SIMON module 66 is employed to retrieve and/or modify the task information, including the above described task lists, and/or to generate the maps and/or driving directions. Task management sub-module 72 retrieves the task information from control system 14 and/or submits modifications to the task information to control system 14. In some embodiments, task management sub-module 72 caches task information in cache 64 to allow retrieval and/or modification of the task information when a connection to control system 14 is unavailable. For example, completed tasks may be cached for a predetermined amount of time, such as sixty days, and therefore accessed without a connection to control system 14. As another example, unscheduled and/or scheduled tasks assigned to a representative may be cached and operated on (e.g., scheduled or unscheduled) by representatives even when a connection to control system 14 is unavailable. In both cases, when the connection is restored, the cache is synchronized with control system 14 (e.g., modifications are submitted to control system 14). Further, task management sub-module 72 typically generates the maps and/or driving directions without control system 14. However, it is also contemplated, that the generation is carried out by control system 14.

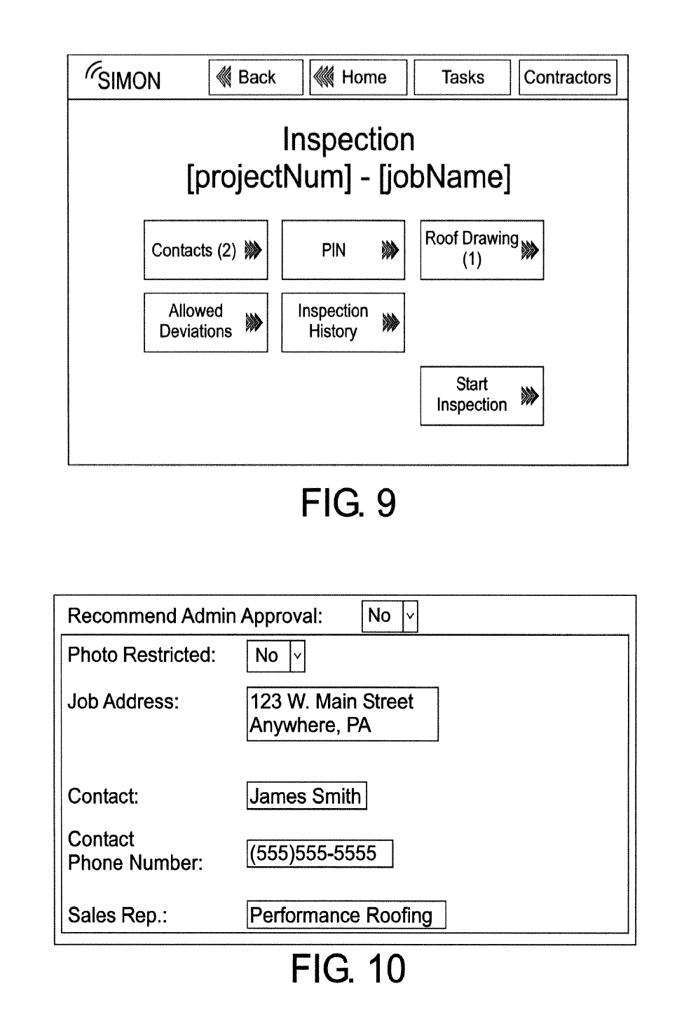

As noted above, task list items are selectable. When a representative selects a task list item, the representative is typically presented with a task page corresponding to the task of the selected task list item, an example of which is shown in FIG. 9. Alternatively, the may be presented with a task-specific form, as discussed below. The task page typically identifies the type of task and the project to which the task belongs, but other identifying information can additionally or alternatively be displayed. As noted above, tasks include, for example, providing installation training, technical customer service, sales support, rooftop inspections (including interim inspections, final inspections and re-inspections), investigating warranty claims and product claims, and the like.

Further, the task page typically allows the representative to read and/or write information regarding the project to which the task relates. The information includes information regarding, for example, one or more of contacts, the PIN, allowed deviations, drawings of the roof, inspection history, leak history, investigation history, contractor invoice, contractor images, previous roof condition analysis, and so on.

When a representative views information regarding contacts of a project, they are typically presented with a list of the contacts associated with the project. Each contact is represented as a contact list item including information regarding one or more parameters of the contact and is optionally expandable and/or selectable to view information regarding additional parameters. Parameters of a contact include one or more of name, email address, phone number (primary and/or secondary) and so on. In some embodiments, the representatives can one or more of add, delete and edit contacts.

When a representative views information regarding roof drawings, the representative is typically presented with graphical representations of drawings associated with the project, including roof plans, discussed below. Drawings can be attached to a project when the project or a corresponding task is created, when a representative completes a task-specific form, discussed below, and so on. In some embodiments, the drawings include markers of areas of interest, such as deficiencies and/or markers of penetrations. Further, in some embodiments, the representatives can one or more of add, delete and edit roof drawings. Even more, in some embodiments, the roof drawings include different layers, such as a base layer with only the roof outline, a penetrations layer with only penetrations through the roof, and an area of interest layer with areas of interest of the roof.

When the roof drawings include layers, the representative may selectively display the layers. For example, the representative may only display the base layer and the area of interest layer. Further, the representative may selectively overlay layers from different roof drawings, such as roof plans from different investigations and/or roof drawings without layers, which are treated as including a single layer. For example, the representative can selectively overlay area of interest layers from two different roof plans with the base layer and penetration layer to see differences between the areas of interest. Even more, the representative may display a plurality of groups of layers, each group including layers from one or more roof plans, adjacent to one another for comparison. To discriminate between individual layers, the layers may be colored and/or otherwise modified to allow differentiation.

The coordinate frames of different images are suitably correlated using geotags embedded in the images. In such instances, geographical coordinates typically allow correlation of the coordinate frames. However, where geotags are not available or otherwise insufficient for correlating coordinate frames, image-based and/or other techniques may be employed to correlate coordinate frames, such as, for example, edge detection of the roof and/or detection of anchor points (i.e., salient points common to all roof drawings).

When a representative views information regarding a PIN, the representative is typically presented with an electronic form including fields for one or more parameters of the PIN associated with the project. Parameters of a PIN include, for example, roof dimensions. As noted above, the PIN is typically added to the project by the contractor of the project. However, insofar as the PIN is a legacy PIN (e.g., an image of a PIN), the image is provided to the representative.

When a representative views information regarding inspection history, investigation history, or leak history, they are typically presented with a list of inspections, investigations, or leaks, respectively, represented as list items. Such a list item can include information pertaining to the inspection, investigation, or leak. In some embodiments, selecting a list item presents the representative with additional information. Alternatively, for inspections and/or investigations, instead of presenting the representative with a list, the representative can be presented with an electronic form including information for the most recent inspection and/or investigation. Generally, if an inspection and/or an investigation were not performed with SIMON module 66, the representative may be presented with an image, such as a PDF, of the inspection and/or the investigation. In some embodiments, when the inspection history, investigation history or the leak history include areas of interest with geostamps, the representative may be presented with instructions directing the representative to the location of the area of interest.

When a representative views information regarding contractor invoice and/or contractor images, the representative is typically presented with the images and/or an electronic form including fields for information regarding one or more parameters of the contractor invoice. As discussed below, the contractor invoice and/or the contractor images are typically added to the project when created and/or when a task is created. Insofar as the contractor invoice is a legacy contractor invoice (e.g., an image of a contractor invoice), the image is provided to the representative.

When the representative views information regarding previous roof condition analysis and/or allowed deviations, the representative is typically presented with an electronic form including fields for information regarding one or more parameters of a prior roof condition analysis and/or allowed deviations. As noted above, the allowed deviations are typically added to the project by a manager when reviewing the PIN. Insofar as the prior roof condition analysis is a legacy contractor invoice (e.g., an image of a contractor invoice), the image is provided to the representative.

The information the representative can view typically varies depending upon the availability of information and the type of task. For inspections, the representative can typically view contacts, the PIN, roof drawings, allowed deviations and inspection history. For investigations, the representative can typically view contacts, the PIN, roof drawings, allowed deviations, investigation history and leak history. For audits, the representative can typically view the PIN, roof drawings, inspection history, contractor invoice, contractor images, leak history, allowed deviations, and investigation history. For product claims, the representative can typically view contacts, the PIN, roof drawings, allowed deviations, and inspection history. For roof condition analysis, the representative can typically view contacts, the PIN, roof drawings and a previous RCA. For training, the representative can typically view contacts, the PIN, roof drawings, inspection history and allowed deviations.

Even more, when a task is scheduled, the representative can open a task-specific form to collect field data to complete the task. The task-specific form collects the data using predetermined fields to the greatest extent possible to promote data standardization. For example, instead of allowing the representative to simply write a generic description of the task, the representative populates a set of fields asking for the relevant data. Further, in some embodiments, the task-specific form presents basic information regarding the task, such as address and contact for the task, such as the first contact. At any time while performing a task, the task-specific form can be saved and suspended, which saves the data collected by the task-specific form for subsequent use and typically marks the task as unscheduled.

For ease of discussion, the field data collected by the task-specific forms can be grouped into the following groups: basic information, training information, event information, claim details, attendees and weather, exterior images, interior images, roof areas, roof images, roof walk, and close-out. However, additional and/or different groups are contemplated. The task-specific forms typically collect data for different subsets of the groups and/or the field data collected for each group typically varies depending upon the task-specific form.

Inspections can collect field data for the basic information, attendees and weather, exterior images, interior images, roof areas, roof images, roof walk, and close-out groups. Product claims can collect field data for the basic information, claim details, attendees and weather, roof areas, roof images, roof walk, and close-out groups. Investigations collect field data for the basic information, attendees and weather, exterior images, interior images, roof images, roof walk, and close-out groups. Audits can collect field data for the basic information, attendees and weather, exterior images, interior images, roof images, roof walk, and close-out groups. Roof condition analyses collect field data for the basic information, attendees and weather, exterior images, interior images, roof images, roof walk, and close-out groups. Trainings can collect roof data for the basic information, training information, event information, roof areas, roof images, roof walk, and close-out groups.

With reference to FIG. 10, one example of a form for collecting field data of a basic information group is provided. The form includes fields for one or more of location of the task, site contact information, the purpose of the visit, claimant contact information, whether administrative approval is recommended, whether photos may be taken during the task, special instructions, how roof access is obtained, the ladder length if roof access requires a ladder, whether the roof is sloped correctly to drain, whether there is evidence of ponding water, the square footage of the roof, and so on. Indicating administrative approval is recommended allows a representative to suspend the task pending review by the representative's manager. In some cases, the representative may be recommending that performance of the task be waived because the contractor is well known and/or trusted, such that performance of the task can be foregone with minimal risk of deficiencies.

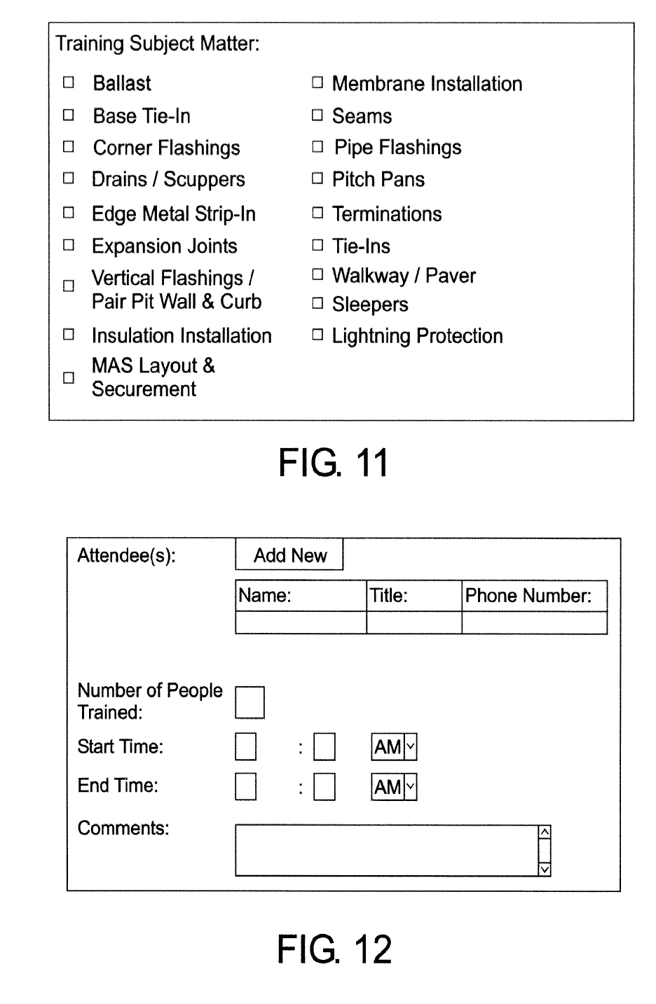

With reference to FIG. 11, one example of a form for collecting the field data of the training information group is provided. The form includes fields for selecting the subject matter of the training. Training subject matter can include, for example, one or more of ballast, base tie-in, corner flashings, drains/scuppers, edge metal strip-in, expansion joints, vertical flashings/pair pit wall & curb, insulation installation, MAS layout & securement, membrane installation, seams, pipe flashings, pitch pans, terminations, tie-ins, walkway/paver, sleepers, lighting protection, and the like.

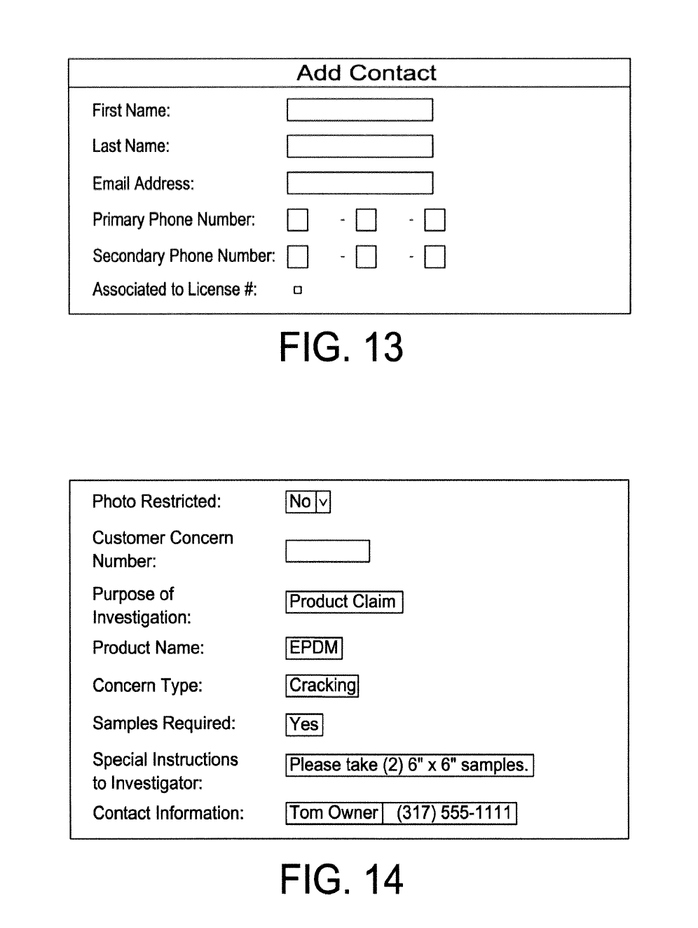

With reference to FIG. 12, one example of a form for collecting the field data of the event information group is provided. The form includes fields for specifying, for example, one or more of attendees of the training, the number of people trained, the start and/or end time to the training, general comments, and the like. Attendee information is suitably collected using a contact form, such as the exemplary form shown in FIG. 13. The contact form includes fields for specifying, for example, one or more of name, email address, phone numbers, and whether to associate the contact to the license number of the contractor. Associating the contact to the license number can add the contact to all tasks associated with the contractor.

With reference to FIG. 14, one example of a form for collecting the field data of the claim details group is provided. The form can include fields for one or more of whether photos may be taken during the task, customer concern number, purpose, product name, concern type, samples required, special instructions, contact name and phone number, and the like.

With reference to FIG. 15, one example of a form for collecting the field data of the attendees and weather group is provided. The form can include fields for collecting one or more of information pertaining to the attendees, weather, and roof visibility. Suitably, information for attendees is collecting using the contact form of FIG. 13.

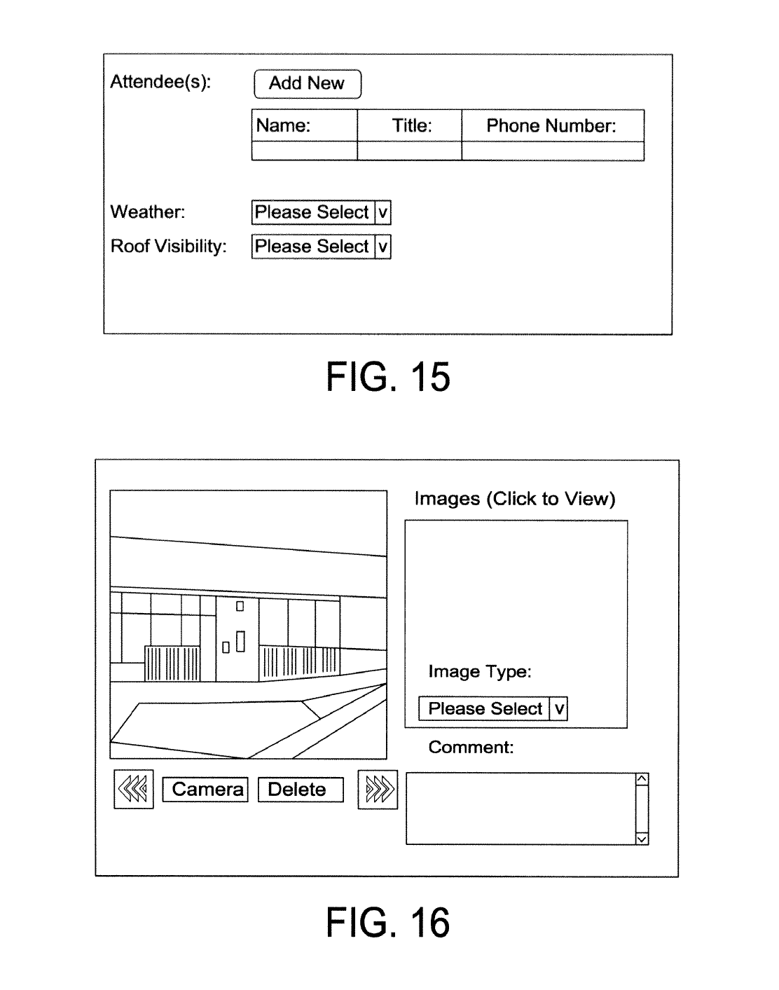

With reference to FIG. 16, one example of a form for collecting the field data of the exterior images group is provided. The form can include fields for collecting images and corresponding information for the exterior of the job location. The representative can add one or more images of the exterior of the project location using image-capture device 60 of the representative device associated with the representative. The representative can also delete images. Each of the added images is typically assigned a geostamp using the location-determination device 62 of the representative device and/or a type, such as front of building, rear of building, side of building, etc. The representative can also add comments for each of the images.

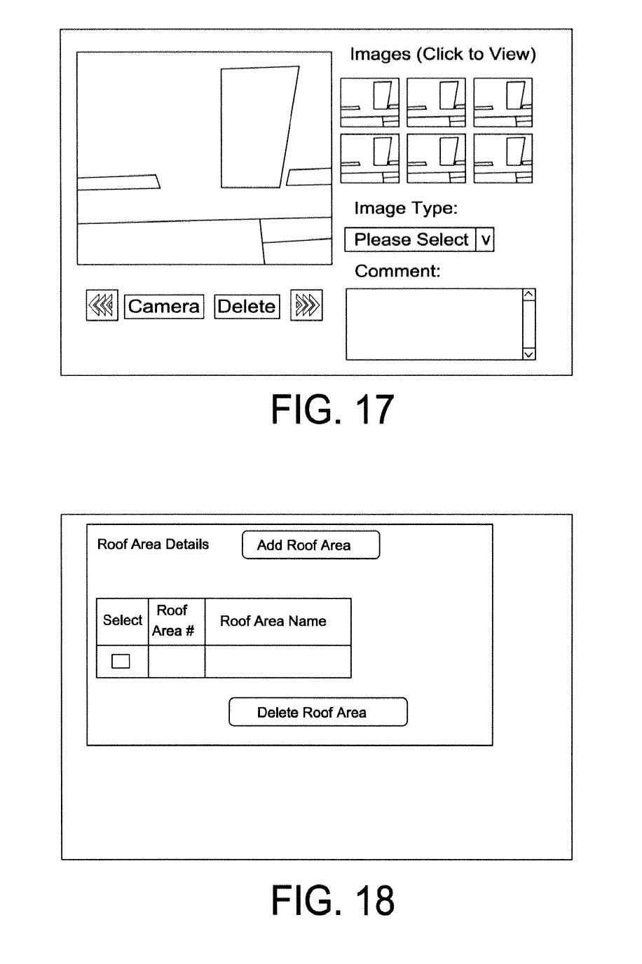

With reference to FIG. 17, one example of a form for collecting the field data of the interior images group is provided. The form can include fields for collecting images and corresponding information for the interior of the project location. The representative can add one or more images of the interior using image-capture device 60 of the representative device associated with the representative. The representative can also delete images. Each of the added images is typically assigned a geostamp using location-determination device 62 of the representative device and/or a type, such as damaged ceiling, leak area, structural damage, etc. The representative can also add comments for each of the images.

With reference to FIG. 18, one example of a form for collecting the field data of the roof areas group is provided. The form allows a representative to add one or more roof areas to the task. For example, a roof project may include a lower roof and an upper roof. At least one roof area is required though. A roof area includes a unique identifier, such as a roof area number, and, optionally, additional identifying information, such as, for example, a roof area name. The representative can additionally delete roof areas.

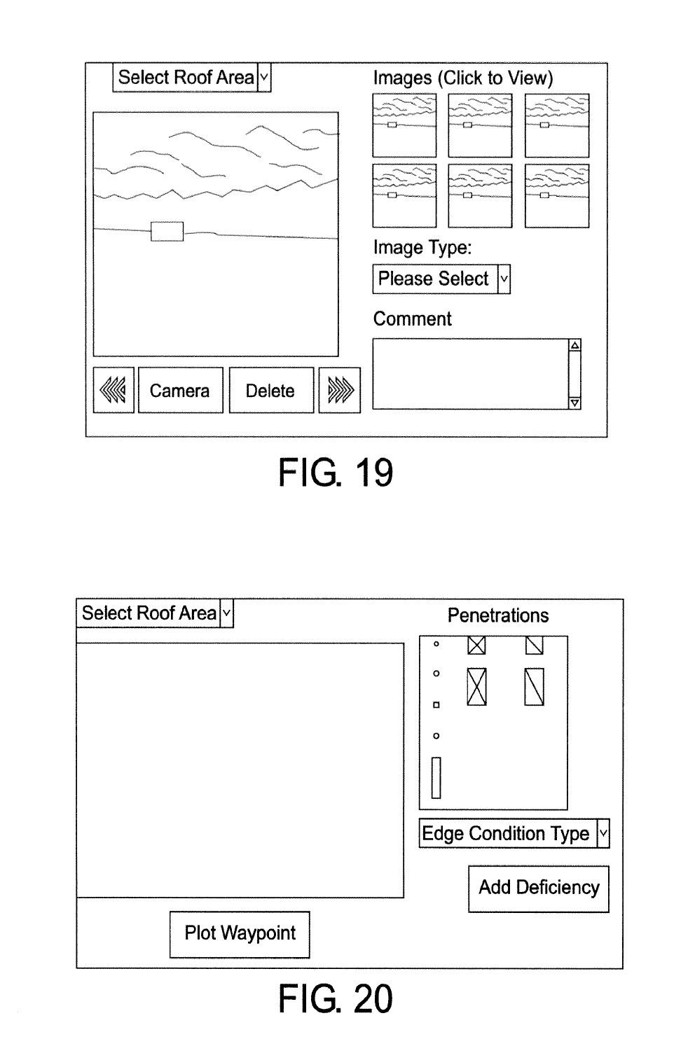

With reference to FIG. 19, one example of a form for collecting the field data of the roof images group is provided. The form allows representatives to add one or more images for each of the roof areas using image-capture device 60 of the representative device associated with the representative. Typically, the representative must provide at least one image for each roof area. Further, each of the added images is typically assigned a geostamp using location-determination device 62 of the representative device and/or a type, such as panoramic, roof overview, etc. For each of the roof areas, the representative can also delete images and add comments for each of the images of the roof area.

With reference to FIG. 20, one example of a form for collecting the field data of the roof walk group is provided. The form allows a representative to define a digital roof plan for each of the roof areas. For each of the roof areas, the representative can define a digital roof plan by plotting waypoints of the roof area (i.e., points along the perimeter of the roof), typically using location-determination unit 62 of the representative device. As the points are added, the points are connected until a complete outline of the roof area is generated. The location of waypoints can additionally or alternatively be explicitly specified, for example, by selecting locations in a coordinate frame. In some embodiments, an edge condition type, such as metal roof edge, parapet with termination, transitional wall with termination, coping, and the like, can be specified for each of the roof areas.

Penetrations and/or areas of interest, such as deficiencies and/or areas of customer concern, can also be added to the roof plan. Markers representative of penetrations and/or areas of interest can be dragged from a legend of markers to corresponding locations on the roof plan and, optionally, scaled as necessary. Additionally, or alternatively, markers representative of penetrations and/or areas of interest can be added to location on the roof plan corresponding to the present location of the representative device on the roof, as determined by location-determination unit 62, and, optionally, moved and/or scaled as necessary. Additionally, or alternatively, markers representative of penetrations and/or areas of interest can be positioned at explicitly specified locations corresponding to the locations of the penetrations and/or areas of interest on the roof plan and, optionally, scaled as necessary. In some embodiments, the locations of the penetrations and/or areas of interest can be used to provide directions to the penetrations and/or areas of interest during subsequent visits using location-determination device 62.

Each of the roof plans may include a plurality of layers. For example, each roof plan may include a layer for the roof perimeter, a layer for the penetrations, and a layer for the areas of interest. As another example, each roof plan may include a layer for the roof perimeter and the penetrations and a separate layer for the areas of interest. In such embodiments, the representative may selectively enable and/or disable layers. Further, in some embodiments, the representative may view layers from other tasks and/or roof drawings of the project overlaid and/or adjacent to layers of the present task. For example, the representative may view an area of interest layer of the present task overlaid on an area of interest layer from a previously performed task for the project. As another example, the representative may view a contractor provided roof drawing overlaid with an area of interest layer of the present task. To discriminate between layers, layers may be colored and otherwise modified.

As above, the coordinate frames of different images are suitably correlated using geotags embedded in the images. In such instances, geographical coordinates typically allow correlation of the coordinate frames. However, where geotags are not available or otherwise insufficient for correlating coordinate frames, image-based and/or other techniques may be employed to correlate coordinate frames, such as, for example, edge detection of the roof and/or detection of anchor points (i.e., salient points common to all roof drawings).

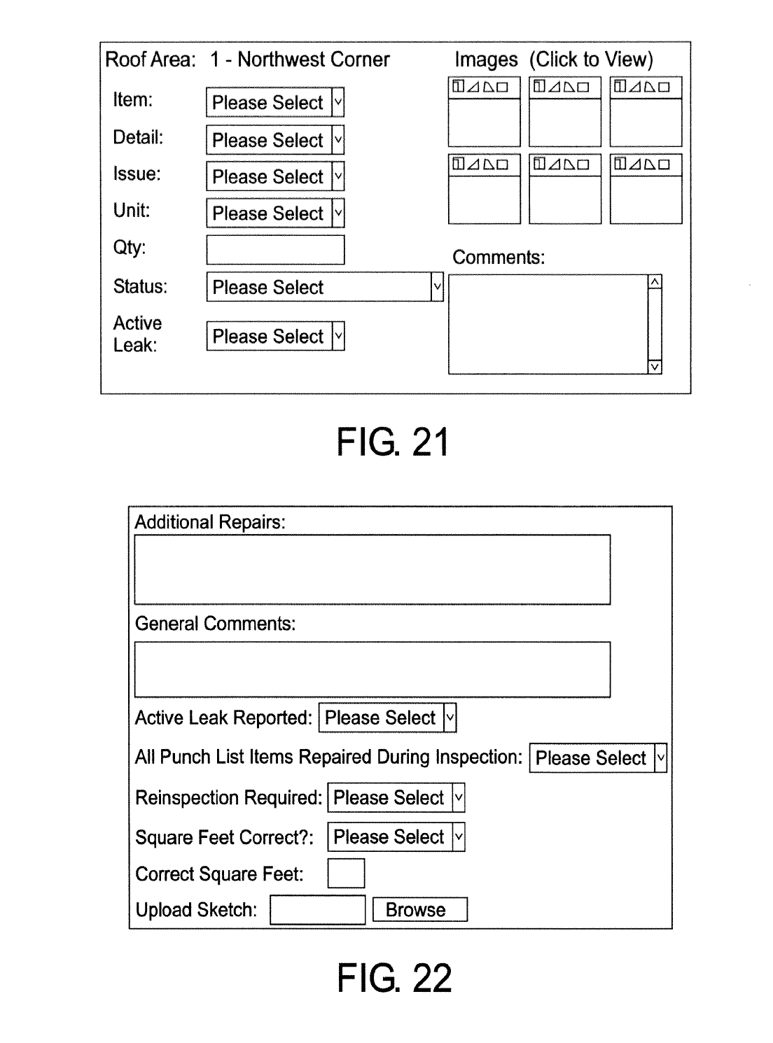

For each area of interest, the representative is typically prompted to capture images of the area of interest and, optionally, specify comments for the images. As shown in exemplary form in FIG. 21, the representative can add one or more images of the area of interest using image-capture device 60 of the representative device associated with the representative. The representative can also associate comments with the images and/or delete images. Each of the added images is typically assigned a geostamp using location-determination device 62 of the representative device.

Additionally or alternatively, for each area of interest, the representative is prompted to enter information pertaining to the area of interest. The form includes, for example, fields for one or more of item; detail; issue; unit (e.g., each, square feet, linear foot, typical, and the like); quantity; status (e.g., repair required, accepted on deviation basis); whether there is an active leak; product name; the type of concern; lot, batch, or panel number; and owner items.

With reference to FIG. 22, one example of a form for collecting the field data of the close-out group is provided. The form includes, for example, fields for collecting information regarding one or more of additional repairs that need to be performed; additional comments; whether an active leak is reported; the number of leaks identified on the roof; whether all deficiencies were repaired during the inspection; whether re-inspection is required; whether the square footage associated with the project is correct; a correct square footage if the square footage associated with the project is incorrect; a sketch; whether the materials on the job were stored properly; comments on improperly stored materials if the materials were stored improperly; a product investigation summary; comments regarding the condition of the roof; whether any non-roofing items are in need of repair and/or maintenance and comments; the approximate age of the roof; an estimate of the remaining roof life; follow-up actions; and the like.

In view of the foregoing, it is to be appreciated that the fields can be pre-populated and, optionally, read only. For example, the product name field is typically prepopulated and typically read only. As another example, the task-specific forms can be saved for subsequent completion. When a representative returns to a previously saved task-specific form, the fields previously filled in will be populated with the previous information. Even more, it is to be appreciated that the task-specific forms can be dynamic. Namely, depending upon how the representative fills out certain fields, other fields may be displayed. Moreover, the task-specific forms suitably include field validation requiring the representatives fill in certain information, while making other information optional. The required fields may also be dependent upon how the representative responds to certain fields.

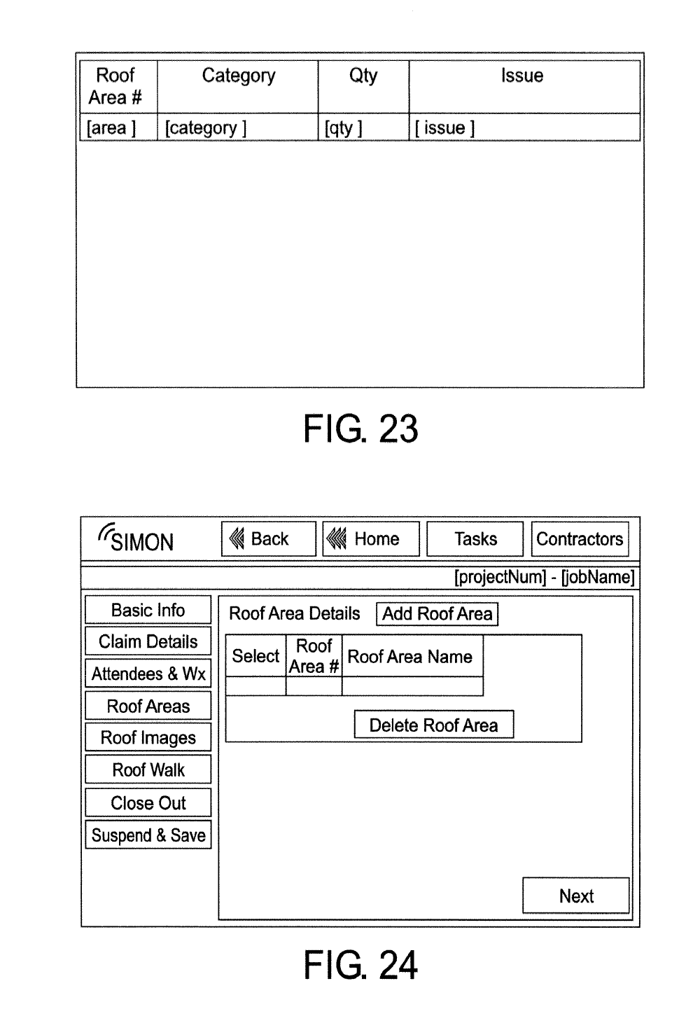

In some embodiments, before a representative submits a completed task-specific form, they are presented with a summary page presenting the representative with at least some of the information collected by the task-specific form. For example, as shown in the exemplary representation in FIG. 23, a representative may be shown a summary page including a listing of areas of interest, represented as list items, each list item including information for parameters of the areas of interest, such as, for example, roof area, category, quantity, and issue. Suitably, the summary page allows the representative to go back and edit any incorrect information.

Further, in some embodiments, the task-specific forms are presented as a series of different pages, typically corresponding to the above described forms for the groups, arranged as a wizard to guide the representative through the data collection process. For example, as illustrated in the exemplary representation in FIG. 24, a task-specific form for product claims spans a plurality of pages that the representative can move between by selecting the next and/or previous buttons or by selecting names associated with the different pages on the left-hand column. The pages include a basic information page, a claim details page, an attendee and weather page, a roof areas page, a roof images pages, a roof walk page, and a close-out page.

Referring back to FIGS. 1 and 2, a task sub-module 74 of SIMON module 66 is employed to retrieve and/or modify the information presented on and/or otherwise accessible from the task page, such as, for example, the PIN of the task and the task-specific form of the task. Task sub-module 74 retrieves the information from and/or submits modification of the information to control system 14, typically over communication network 16. Further, task sub-module 74 is employed to submit field data collected from the representative to control system 14 and determine the fields and/or flow for the task-specific forms. Task sub-module 74 submits the field data collected from the representatives to control system 14, typically over communication network 16.

In some embodiments, the information may be retrieved from and/or modifications to the information and/or submissions of the task-specific forms may be submitted to cache 64 when a connection to control system 14 is unavailable. In that regard, information for projects the representative has worked on over the past predetermined number of days, such as sixty days, and/or is scheduled to work on over the next predetermined number of days, such as ten days, may be stored in cache 64. When a representative completes a task-specific form or modifies the information, the task-specific form and/or the modifications may be stored in cache 64. When a connection to control system 14 is restored, cache 64 is synchronized with control system 14. For example, submissions of task-specific forms are submitted to the control system 14.

Further, in some embodiments, SIMON module 66 and/or the user interface may receive updates and/or customizations from control system 14. Customizations can be global and/or user specific (e.g., user preferences). For example, the layouts and the fields of the task-specific forms may be updated and/or customized by control system 14. As another example, the information display on the home page may be updated and/or customized by control system 14.

Manager devices 22 are typically desktop or laptop computers allowing managers to access control system 14 over communication network 16 to perform one or more operations. The managers are typically one or more staff of warranty claims departments, quality departments, QBS departments, IT departments and the like of the roofing manufacturer. Depending upon the department, the managers may have different access controls limiting the ability to perform certain tasks. For example, a manager in the IT department may have access to user management, whereas a manager in the warranty claims department does not.

Operations include one or more of creating and assigning tasks to the representatives, creating projects, reviewing one or more of field data, warranty claims, and PINs submitted to the control system by the customers and/or the representatives, customizing the menu lists and/or menu items in the user interfaces of users of the roofing system, adding and/or deleting users, managing access controls of the users, adding supporting documents to tasks when a task is created and/or after a task is created, reconciling addresses when a system generated address does not map correctly, monitor productivity, and the like. Typically, after reviewing warranty claims and/or PINs, the managers create projects and/or create and/or assign tasks to representatives.

In some embodiments, the field data is analyzed and used to develop reports to increase efficiencies of fieldwork and/or drive improvement of application specifications, current products, training programs, future product development, and the like. As is to be appreciated, field data is collected to the greatest extent possible using a menu system for data standardization, so it may be used for analysis and/or searching. In certain embodiments, these reports include one or more of activities performed by representatives, Pareto analysis of roof deficiencies, trend analysis of roofing systems and components, and the like.

To aid managers in performance of operations, manager devices 22 provide the managers with a user interface on the corresponding display device for receiving user input from the corresponding user input device to access the control system. The user interface is typically a web page hosted by control system 14. However, other types of user interfaces are contemplated. For example, the user interface can be a software module installed on manager devices 22. In some embodiments, the software module and/or the user interface may receive updates and/or customizations from control system 14. Customizations can be global and/or user specific (e.g., user preferences).

In some embodiments, the software module and/or the user interface caches data locally to allow the managers to carry out one of more of the above described operations. As to creation of new information and/or modification of existing information, the manager can make the creations and/or modifications to the cache, which saves the information until a connection to control system 14 is established. The information is then transmitted to control system 14. As to viewing information on control system 14, the cache stores information from control system 14. The stored information can, for example, include information for projects with activity over a past predetermined amount of time, such as sixty days.

Control system 14 manages users of system 10. In that regard, control system 14 maintains user records in one or more databases 76. A user record includes one or more of general information regarding a user, such name, address, etc., authentication credentials, such as a username and/or password, access controls, user preferences, and so on. Access controls, for example, indicate what data the user has access to and/or operations the user is allowed to perform. User preferences control the appearance of the user interfaces employed by the users to access control system 14. Users, typically only managers, can access control system 14 to create and/or delete user records. Further, users can access control system 14 to view and/or edit user records.

Control system 14 further manages the exchange of messages. In that regard, control system 14 maintains messages in databases 76. A message includes one or more of a sender, such as a user or a component of system 10, a recipient, such as a user of the system, a subject, a message body, and so on. In some embodiments, databases 76 employ email storage formats, such as mbox, maildir, personal storage table (PST), and so on. Users can access control system 14 to read and/or delete their messages and create and send messages to users of control system 14. In some embodiments, an email communication protocol, such as IMAP, POP, and SMTP, can be used for the exchange of messages.

Control system 14 further manages PINs. In that regard, the control system 14 maintains PINs in databases 76. A PIN includes, for example, one or more of a unique identifier, a location, a contractor, a roof size, a membrane type, a roofing system, at least one contact and so on. Users can access control system 14 to create and/or delete PINs. Further, users can access control system 14 to edit PINs. Control system 14 further manages projects. In that regard, control system 14 maintains projects in databases 76. A project includes one or more of a unique identifier, a name, a warranted square footage, a quality insurance rating, a pre-installation notice (PIN), optionally at least one allowed deviations, at least one contact, at least one task, and so on. Users, typically only managers, can access control system 14 to create and/or delete projects. Further, users can access control system 14 to edit projects.

Control system 14 further manages tasks. In that regard, control system 14 maintains tasks in databases 76. A task includes one or more of a unique identifier, a type, a project, a request for inspection date, an assigned user, field data, and so on. As with projects, users can access control system 14 to create and/or delete tasks. Further, users can access control system 14 to edit tasks. For example, a representative can reassign a task to another representative.

Control system 14 further manages field data. In that regard, control system 14 maintains field records in databases 76. A field record includes one or more of a unique identifier, a task, field data, and so on. Field data includes, for example, images, a collection of geostamps creating a roof drawing, and so on. Users can access control system 14 to create and/or delete field records. Further, users can access control system 14 to view and/or edit field records.

In some embodiments, control system 14 further manages legacy data. In that regard, control system 14 maintains legacy records in databases 76. A legacy record includes one or more of a unique identifier, a task, legacy field data, and so on. Legacy field data includes task-specific forms, such as investigation forms, inspection forms, and the like, typically stored in an image format including vector based image formats, such as PDFs. Users can access control system 14 to create and/or delete legacy records. Further, users can access control system 14 to view and/or edit legacy records.

Even more, in some embodiments, control system 14 manages configurable parameters of user interfaces and/or programs the users employ to access control system 14. Configurable parameters include one or more of menu lists and menu items, layout, and so on. For example, it is contemplated that a manager can create a task-specific form used by SIMON module 66 and/or modify one of the task-specific forms used by SIMON module 66. The configurable parameters are suitably stored in databases 76 and accessible by the users.

Further, in some embodiments, control system 14 calculates statistics indicating the performance of the representatives and makes such statistics available to users. For example, control system 14 can calculate the weekly task average over a predetermined period of time, such as three months, for each of the representatives and the average weekly task average over the predetermined period of time for a group of representatives, such as all the national representatives. As another example, control system 14 can calculate the total tasks completed over a predetermined period of time, such as the calendar year, for each of the representatives.

Moreover, in some embodiments, control system 14 generates maps of tasks and/or driving directions to tasks in response to requests therefor. As discussed above in connection with SIMON module 66, the generated maps display the geographical location of one or more tasks as selectable markers, the tasks typically corresponding to the tasks of a listing (optionally filtered) of tasks, such as unscheduled pending tasks, scheduled pending tasks, and so on.

When a user attempts to access control system 14, control system 14 authenticates the user and, where applicable, verifies the user is authorized using the access controls associated with the authenticated user. For example, representatives are typically limited to their data and data pertinent to their assigned tasks. As such, users are generally unable to access the data of other users, such as messages, and access data beyond their assignments.

Further, in some embodiments, control system 14, monitors the tasks assigned to the representatives and generates messages reminding the representatives of past due tasks and/or tasks scheduled for today. For example, control system 14 creates a new message in the message database for a representative indicating that a task associated with the representative is past due.

Even more, in some embodiments, when a field record is created, control system 14 provides notice to the customer associated with the field record and/or a copy of the field data associated with the field record is provided to the customer. Moreover, in some embodiments, when a field record is created, a copy of the field data associated with the field record is provided to one or more legacy systems, such as legacy workflow systems or document management systems.

Moreover, in some embodiments, control system 14 allows the users to search databases 76. In some embodiments, the searches are complex searches including a query language, whereas, in other embodiments, the searches are simple keyword searches. A query language includes, for example, a plurality of connectors defining the relationship between words, such as ADJ for adjacent, SAME for same paragraph, and so on.

Control system 14 includes one or more servers 78 and databases 76 (i.e., one or more database). It is contemplated that servers 78 and/or databases 76 are distributed at varying locations within control system 14 or centrally located therein. Databases 76 store the above-noted data and servers 78 provide user devices 12 an interface to access databases 76 over communications network 16. Further, servers 78 allow users devices 12 to perform the above-noted operations. In certain embodiments, servers 78 further host a web application to be run by user devices 12 using a web browser, such as MICROSOFT INTERNET EXPLORER, for example.

Each of servers 78 includes a communications unit 80, a memory 82, a processor 84, at least one data bus 86, and the like. Further, in some embodiments, servers 78 include databases 76. Communications units 80 allow servers 78 to interact with each other and other components of system 10, such as user devices 12, over, for example, communication network 16. Communications units 80 further, in some embodiments, allow servers 78 to interact with databases 76 over a communication network or a data bus, such as data buses 86. Memories 82 include computer executable instructions for performing the above-noted functions associated with control system 14, which processors execute 84. Data buses 86 interconnect the components of servers 78.

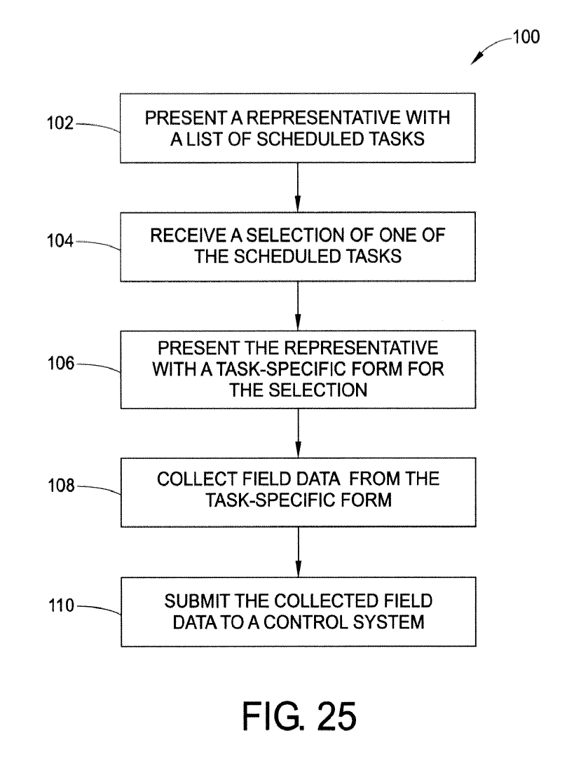

With reference to FIG. 25, a method 100 managing field technical representatives is provided. The method 100 is suitably carried out by a representative device 18 using a processor 28 thereof. It includes presenting 102 the associated field technical representative with a list of selectable scheduled tasks assigned to the field technical representative. As above, each of the selectable scheduled tasks is associated with a roof. A selection of one of the selectable scheduled tasks is received 104 from the field technical representative and the field technical representative is presented 106 with a task-specific form for the selected scheduled task. The task-specific form includes a plurality of fields to collect field data for the roof of the selected scheduled task from the field technical representatives. Field data from the field technical representative is collected 108 using the task-specific form. The field data includes a roof plan of the roof of the selected scheduled task and the roof plan includes a plurality of waypoints defining the perimeter of the roof of the selected scheduled task and one or more areas of interest of the roof of the selected task. The collected field data is submitted 110 to the central control system 14.

As used herein, a memory includes one or more of a non-transient computer readable medium; a magnetic disk or other magnetic storage medium; an optical disk or other optical storage medium; a random access memory (RAM), read-only memory (ROM), or other electronic memory device or chip or set of operatively interconnected chips; an Internet server from which the stored instructions may be retrieved via the Internet or a local area network; or so forth. Further, as used herein, a processor include one or more of a microprocessor, a microcontroller, a graphic processing unit (GPU), an application-specific integrated circuit (ASIC), a field-programmable gate array (FPGA), and the like; a communications network includes one or more of the Internet, a local area network, a wide area network, a wireless network, a wired network, a cellular network, and the like; a data bus includes one or more of USB, I2C, SCSI, SATA, Firewire, and the like; a user input device includes one or more of a mouse, a keyboard, a touch screen display, one or more buttons, one or more switches, one or more toggles, and the like; a cache includes one or more memories; a database includes one or more memories; and a display includes one or more of a LCD display, an LED display, a plasma display, a projection display, a touch screen display, and the like.

As used herein with reference to certain features, elements, components and/or structures, numerical ordinals (e.g., first, second, third, fourth, etc.) may be used to denote different singles of a plurality or otherwise identify certain features, elements, components and/or structures, and do not imply any order or sequence unless specifically defined by the claim language.

It will be recognized that numerous different features and/or components are presented in the embodiments shown and described herein, and that no one embodiment is specifically shown and described as including all such features and components. However, it is to be understood that the subject matter of the present disclosure is intended to encompass any and all combinations of the different features and components that are shown and described herein, and, without limitation, that any suitable arrangement of features and components, in any combination, can be used. Thus it is to be distinctly understood claims directed to any such combination of features and/or components, whether or not specifically embodied herein, are intended to find support in the present disclosure.

Thus, while the subject matter of the present disclosure has been described with reference to the foregoing embodiments and considerable emphasis has been placed herein on the structures and structural interrelationships between the component parts of the embodiments disclosed, it will be appreciated that other embodiments can be made and that many changes can be made in the embodiments illustrated and described without departing from the principles hereof. Obviously, modifications and alterations will occur to others upon reading and understanding the preceding detailed description. Accordingly, it is to be distinctly understood that the foregoing descriptive matter is to be interpreted merely as illustrative of the subject matter of the present disclosure and not as a limitation. As such, it is intended that the subject matter of the present disclosure be construed as including all such modifications and alterations insofar as they come within the scope of the appended claims and any equivalents thereof.

1. A portable representative device for managing the administrative workload of a field technical representative, the portable representative device comprising:
present a field technical representative with a list of selectable scheduled tasks assigned to the field technical representative with at least one of the selectable scheduled tasks associated with a roof;
receive a selection of one of the selectable scheduled tasks associated with a roof from the field technical representative;
present the field technical representative with a task-specific form for the selected scheduled task, the task-specific form including a plurality of fields to collect field data for the roof of the selected scheduled task from the field technical representatives;
collect field data from the field technical representative using the task-specific form, the field data including a roof plan of the roof of the selected scheduled task, the roof plan including a plurality of waypoints defining the perimeter of the roof of the selected scheduled task and one or more areas of interest of the roof of the selected task; and,
submit the collected field data to a central control system.

2. A portable representative device according to claim 1, wherein the at least one processor is programmed such that the task-specific form is for one of installation training, technical customer service, sales support, rooftop inspection, warranty claim investigation, and product claim investigation.

3. A portable representative device according to claim 1, wherein the at least one processor is further programmed to:
present the field technical representative with information regarding the roof of the selected scheduled task previously added to the central control system.

4. A portable representative device according to claim 1, wherein the locations of the waypoints and/or the areas of interest on the roof plan are determined using a positioning system.

5. A portable representative device according to claim 1, wherein the roof plan includes data corresponding to a plurality of layers, the layers including a layer with the waypoints and a layer with the areas of interest.

6. A portable representative device according to claim 1, wherein the at least one processor is further programmed to:
present the field technical representative with a list of selectable tasks assigned to the field technical representative, the list of selectable tasks including the list of selectable scheduled tasks and/or another list;
receive a selection of one of the selectable tasks from the field technical representative;
present the field technical representative with a selectable action object corresponding to an operation to be performed on the selected task;
receive a selection of the selectable action object; and,
perform the operation on the selected task.

7. A portable representative device according to claim 1, wherein the at least one processor is further programmed to at least one of;
reassign a selected task to another field technical representative;
unscheduled a selected task;
generate driving directions to a location associated with a selected task; and,
display a location associated with a selected task on a map.

8. A portable representative device according to claim 1, wherein the at least one processor is further programmed to:
present the field technical representative with a list of selectable unscheduled tasks assigned to the field technical representative;
receive a selection of one of the selectable unscheduled tasks and scheduling information from the field technical representative; and,
schedule the selected unscheduled task with the scheduling information, the scheduling including submitting the scheduling information to the central control system.

9. A portable representative device according to claim 1, wherein the at least one processor is further programmed to:
present the field technical representative with a plurality of drawings of the roof of the selected scheduled task, including the roof plan, the plurality of drawings including selectable layers;
receive a selection of at least two selectable layers of the plurality of drawings from the field technical representative;
overlay the selected layers; and,
present the overlay to the field technical representative.

10. A portable representative device according to claim 1, wherein submitting the collected field data includes:
determining whether a data connection to the central control system is available; and,
saving the collected field data in a memory of the portable representative device until the data connection is available.

11. A system for managing the administrative workload of field technical representatives, the system comprising:
a plurality of portable representative devices including the portable representative device according to claim 1; and,
a central control system including one or more databases and at least one processor programmed to:
receive field data collected from the task-specific forms; and,
store the received field data in the databases; and,

12. A system according to claim 11, further including:
a contractor device submitting a pre-installation notice to the central control system for one of the roofs of the selected scheduled tasks.

13. A system according to claim 11, further including:
a manager device programmed to create and assign the selected task to the field technical representative through the central control system.

14. A system according to claim 13, wherein the manager device is further programmed to generate reports from field data received from the plurality of portable representative devices.

15. A method for managing field technical representatives, the method comprising:
presenting by at least one processor a field technical representative with a list of selectable scheduled tasks assigned to the field technical representative with at least one of the selectable scheduled tasks associated with a roof;
receiving by the processor a selection of one of the selectable scheduled tasks from the field technical representative;
presenting by the processor the field technical representative with a task-specific form for the selected scheduled task, the task-specific form including a plurality of fields to collect field data for the roof of the selected scheduled task from the field technical representatives;
collecting field data from the field technical representative using the task-specific form, the field data including a roof plan of the roof of the selected scheduled task, the roof plan including a plurality of waypoints defining the perimeter of the roof of the selected scheduled task and one or more areas of interest of the roof of the selected task; and,
submitting by the processor the collected field data to a central control system.

16. A method according to claim 15, the method further including:
Presenting the field technical representative with a plurality of drawings of the roof of the selected scheduled task, including the roof plan, the plurality of drawings including selectable layers;
receiving a selection of at least two selectable layers of the plurality of drawings from the field technical representative;
overlaying the selected layers; and,
presenting the overlay to the field technical representative.

17. A method according to claim 15, the method further including:
presenting the field technical representative with a list of selectable unscheduled tasks assigned to the field technical representative;
receiving a selection of one of the selectable unscheduled tasks and scheduling information from the field technical representative;
scheduling the selected unscheduled task with the scheduling information, the scheduling including submitting the scheduling information to the central control system.

18. A method according to claim 15, wherein submitting includes:
determining whether a data connection to the central control system is available; and,
saving the collected field data in a memory until the data connecting is available.

19. A method according to claim 15, wherein the task-specific form is for one of installation training, technical customer service, sales support, rooftop inspection, warranty claim investigation, and product claim investigation.

20. A non-transitory computer readable medium carrying software for controlling at least one processor to perform the method according to claim 15.
